(19) United States
(12) Patent Application Publication
(10) Pub. No.: US 2008/0281708 A1
(43) Pub. Date: Nov. 13, 2008

(54) SYSTEMS AND METHODS FOR PROVIDING A TELEPHONY-BASED CONTENT PORTAL

(75) Inventor: Andrew Deal, Vancouver, WA (US)

Correspondence Address: Ruttler Law PLLC;One Union Square, 600 University Street, Suite 1919, Seattle, WA, 98101, US

(73) Assignee: CELLECAST, Vancouver, WA (US)

(21) Appl. No.: 12/117,663

(22) Filed: May 8, 2008

Related U.S. Application Data
(60) Provisional application No. 60/916,790, filed on May 8, 2007.

(51) Int. Cl. G06Q 30/00

(52) U.S. Cl. 705/14

(57) ABSTRACT

This invention relates generally to software and more specifically to systems and methods for providing a telephony-based content portal. In one embodiment, the invention includes a system for providing a content portal, the system including a computer system, the computer system being accessible to a content producer, an advertiser, and a consuming device over a communications network, the computer system configurable to receiving content from the content producer and an advertisement from the advertiser, the computer system configurable to distributing the content and the advertisement to a consumer upon the consumer accessing the computer system using the consuming device, and the computer system configurable to providing transport controls for any of the content and the advertisement. In a further embodiment, the communications network is a telephony-based network, the consuming device is a mobile phone, and the content is any of audio and visual.

### PRIORITY CLAIM

This application claims the benefit of U.S. Provisional Application No. 60/916,790 filed May 8, 2007. The foregoing application is incorporated by reference in its entirety as if fully set forth herein.

### FIELD OF THE INVENTION

This invention relates generally to software and more specifically to systems and methods for providing a telephony-based content portal.

### BACKGROUND

Audio content, such as radio talk shows, is traditionally streamed to consumers via radio receivers. In order to listen to audio content, consumers must listen to the audio content during its scheduled transmission. Consumers are not able to rewind, pause, save, fast forward, or forward audio content and are not able to easily interact with content producers without a separate phone and a little luck getting through. Furthermore, while advertisers include advertisements within the audio content, it is difficult for advertisers to determine the effectiveness of the advertisements and to specifically target the advertisements to specific consumers. When consumers hear advertisements of interest, they are not able to obtain further information on the advertisement or easily purchase the product or service advertised without a separate visit or call to the advertiser. Additionally, it is difficult for individuals to independently create and distribute audio content to other consumers and to independently create advertisements for inclusion in distributed audio content. Accordingly, while progress has been made in the art, there exists much room for improvement. What are needed are systems and methods for providing a telephony-based content portal.

### SUMMARY

This invention relates generally to software and more specifically to systems and methods for providing a telephony-based content portal. In one embodiment, the invention includes a system for providing a content portal, the system including a computer system, the computer system being accessible to a content producer, an advertiser, and a consuming device over a communications network, the computer system configurable to receiving content from the content producer and an advertisement from the advertiser, the computer system configurable to distributing the content and the advertisement to a consumer upon the consumer accessing the computer system using the consuming device, and the computer system configurable to providing transport controls for any of the content and the advertisement. In a further embodiment, the communications network is a telephony-based network, the consuming device is a mobile phone, and the content is any of audio and visual.

### BRIEF DESCRIPTION OF THE DRAWINGS

Embodiments of the present invention are described in detail below with reference to the following drawings:

FIG. 1 is a block diagram of a system for providing a telephony-based content portal, in accordance with an embodiment of the invention; and

FIG. 2 is a block diagram of a method for providing a telephony-based content portal, in accordance with an embodiment of the invention.

### DETAILED DESCRIPTION

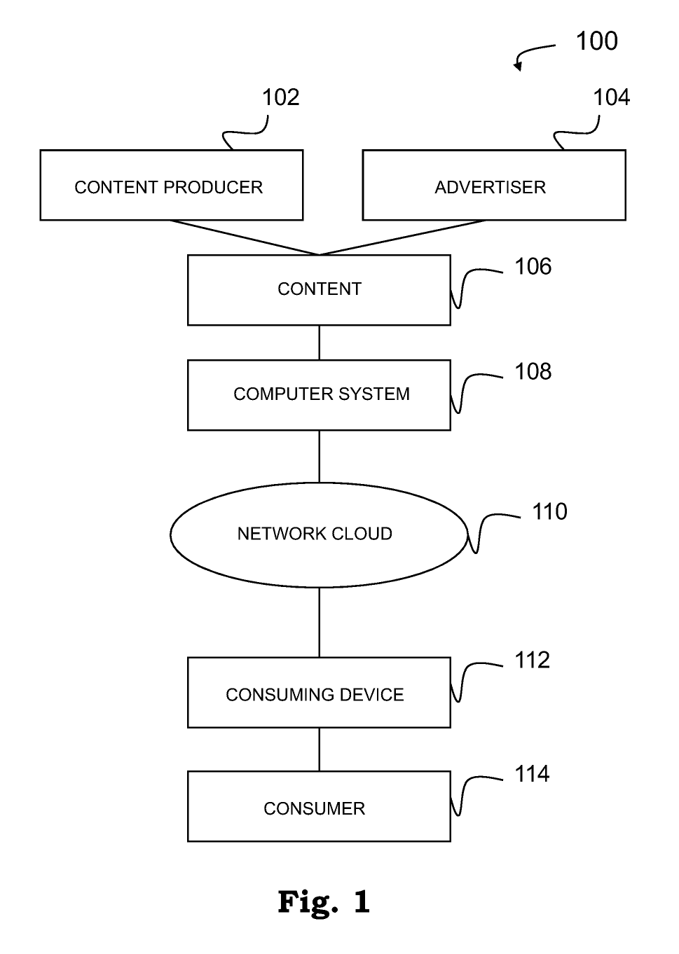

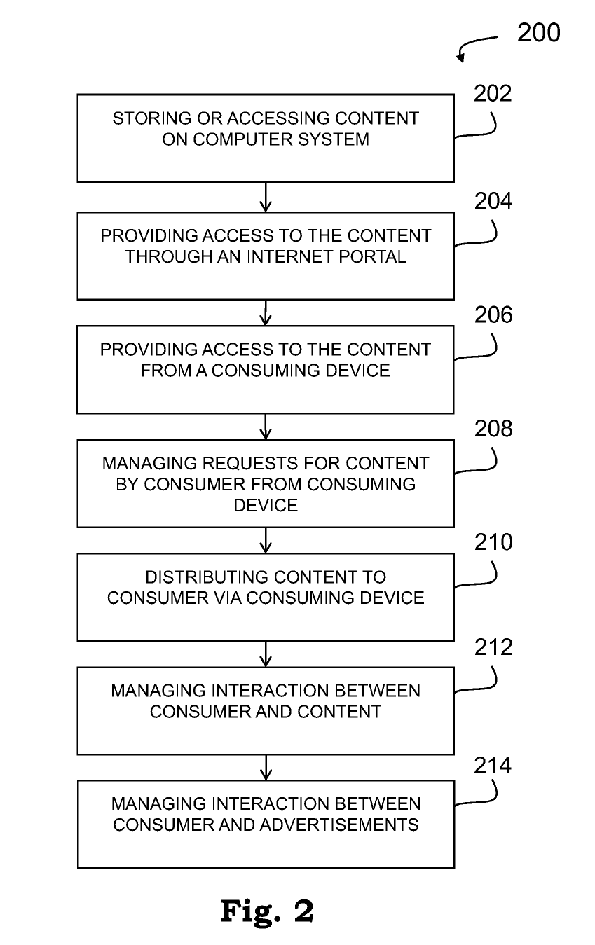

This invention relates generally to content distribution, and more specifically, to systems and methods for providing a telephony-based content portal. Specific details of certain embodiments of the invention are set forth in FIGS. 1-2, APPENDIX A-B, and in the following description to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a block diagram of a system for providing a telephony-based content portal, in accordance with an embodiment of the invention. In one embodiment, the invention couples content producers, advertisers, and consumers over a telephony-based network, wherein the consumers are configurable to access and receive personalizable and on-demand audio, text, or video content (hereinafter “content”) from a computer system using a consuming device. In certain embodiments, the telephony-based network is substituted or complimented with a computer network such as the internet. The consuming device is any telephone, mobile telephone, personal digital assistant, computer, or other similar device. The invention eliminates scheduling barriers making it possible for consumers to access desired content at any time and from any location using a consuming device; provides more choices and control to consumers for content consumption; introduces options for providing interactive content and advertisements; and introduces additional revenue generation avenues.

In one embodiment, the content includes any of talk radio shows, radio station broadcasts, podcasts, music, news, traffic reports, movies, television shows, videos, books, blogs, government notices, emergency notices, political communications, distance learning/educational programs, or any other audio, text, or visual content. In one particular embodiment, the content is obtained from traditional content producers such as television networks, radio stations, or newspapers wherein the content producers are motivated to make the content available to consumers for increased flexibility to consumers, improved consumer retention rates, increased consumer bases, and new revenue streams. In another embodiment, the content includes independently generated content such as podcasts, blogs, or video content. The content is stored on or accessible to the computer system and is accessible by the consumer using the consuming device. In certain embodiments, the content is access restricted to certain consumers using passwords or other unique identifiers.

In an alternate embodiment, the independently generated content includes message broadcasts, such as business, organization, group, family, or personal messages, for dissemination to a defined set of consumers. For example, an entity can capture an audio, text, or visual message using a consuming device and provide contact information for one or more consumers. The computer system accepts the independently generated content and contact information and sends, such as via a text message, an email message, or a phone call, or makes available, such as by sending instructions for accessing the content, the content to the one or more consumers. In one particular embodiment, the computer system determines whether the one or more consumers have a pre-defined preferred method for content delivery and sends or makes available the content based upon that preferred delivery method. Also, the computer system may consider urgency settings when determining how to send or make available the content to the one or more consumers. In yet a further embodiment, the computer system provides or makes available report details to the entity as to whether and when the one or more consumers consumed the content. In an alternative embodiment, consumption of the content is confirmable with an audio or text message. In yet a further embodiment, the one or more consumers can similarly capture a message for reply to the entity or for forwarding to one or more other consumers. Accordingly, an entity can become a content producer for thousands, millions, or more consumers. Thus, sales seminars, songs, company updates, meeting notes, board meetings, initiatives, lectures, sermons, family messages, sporting event updates, school closures, team practice schedules, emergency notices, home movies, presentations, seminars, courses, and any other audio, text, or visual content can be easily captured and distributed to one or more consumers. In one particular embodiment, fees are required to send or access consumer-generated content.

In one embodiment, the advertiser includes any entity seeking to promote a product, a service, an entity, or some other tangible or intangible through an audio, visual, or text based advertisement. The advertisement is stored on or accessible to the computer system and is accessible by the consumer using the consuming device. The advertisement is included within the content for consumption by the consumer; although if the consumer is subscribed to an advertisement-free service, then no advertisements may be included in the content. In one particular embodiment, the advertisement included within content is tailored to the consumer's communication network provider, consumer geography, consumer demographics, consumer preferences, consumer consumption history, or consumed content, any of which are automatically obtainable or volunteerable by the consumer. For example, when the consumer accesses the computer system for content consumption, the advertisements that best fit the demographic or geography of the consumer are selected from an advertisement database and loaded into an array for delivery along with the content accessed by the consumer. The priority of the advertisements relative to the content may be random or dictated by an administrator. For example, content sponsorship advertisements may be given priority when delivered with the sponsored content to the consumer. In one embodiment, a filter is applied against the array to filter the advertisements delivered to the consumer based upon whether they are allowed with the content being accessed by the consumer. In one particular embodiment, the same advertisement is not duplicatably delivered to the consumer until all the advertisements within the array are delivered at least once.

In another embodiment, the advertisement includes an “engage now” function, whereby the consumer is able to interrupt a consumed advertisement using the consuming device interface to engage with a representative of the advertisement, request contact from a representative of the advertisement, request an electronic, physical, or audible message regarding the advertisement, bookmark the advertisement for later review, make a purchase for the subject matter of the advertisement, or take other similar actions (see APPENDIX A for source code examples). For example, in one particular embodiment, when the consumed advertisement includes an “engage now” function, the consumer uses the consuming device to manually or audibly make selections for (1) rewinding, pausing, restarting, resuming, fast forwarding, or skipping the advertisement (a skipped advertisement may be less likely to be re-delivered to the consumer); (2) requesting more advertisement details, requesting a message for the advertisement, or requesting help; (3) engaging with a representative for the advertisement, such as using VOIP (any communication network charges may be billable to the advertiser), leaving a message for the advertiser, or purchasing a product or service related to the advertisement. Any of the foregoing selections may be omitted or disabled and others may be added. Further, any of the foregoing selections may be accompanied by audio or visual instructions. In one particular embodiment, to facilitate purchasing a product or service related to the advertisement, the consumer pre-supplies credit card or other payment information, a shipping address, a billing address, contact information, or other similar information, which is stored on or accessible to the computer system. Any purchase request is then communicated to the advertiser along with the payment, shipping, billing, contact, or other useful information to facilitate the purchase transaction.

In yet another embodiment, the advertisement is an independently generated advertisement by an entity and is capturable with or using the consuming device. The independently generated advertisement is then includable in content for consumption by one or more consumers as discussed herein. In one particular embodiment, the entity generating the advertisement is required to pay a fee, which may be a pay-per-consumer access or interaction fee. Thus, an entity can create an audio, visual, or text advertisement, such as one promoting their product or service, and have the independently generated advertisement included with content that is consumed by one or more consumers.

FIG. 2 is a block diagram of a method for providing a telephony-based content portal, in accordance with an embodiment of the invention. In one embodiment, content and any advertisement are stored on or accessed by a computer system. A consumer uses a consuming device to access the computer system and the content and any advertisement over a communication network. The computer system manages access to the content and any advertisement from the consumer and manages any interaction between the consumer and the content and any advertisement. In one embodiment, the computer system includes an internet interface for the consumer to update settings and preferences, locate desired content, establish playlists, listen to desired content, input payment information, and take other actions as described anywhere herein. For example, the internet interface is usable to set up starting sub-menus and initial playlists to make access to content from the consuming device easier. In one particular embodiment, the content and the advertisement are audio, the consuming device is a telephone or mobile phone, and the communication network is a telephony-based network. In another particular embodiment, the consuming device does not require any modification or additional software to access the content. Instead, an existing consuming device having a user interface, such as key pad, voice receiver, or touch display, is usable to access and interact with streamed or downloadable content and any advertisement from the computer system. In certain embodiments, the consuming device is configurable to performing at least some of the functions of the computer system.

Upon the computer system being accessed by the consuming device over the communication network, the consumer is presented with a welcome message and a menu that provides options for the consumer to browse and access desired content using consuming device and communication network independent protocols and user interfaces. In one particular embodiment, the browsing and accessing is accomplished using voice recognition software or touchtone key entry. In another particular embodiment, the consumer uses a specific phone number or other identifier to directly access a submenu or specific content thereby facilitating access to content. In a further embodiment, the consumer is able to search through audio phonetic indexes of content archives to locate content having a phrase match. The consumer provides a voice or text phrase, which is translated into phonemes and matched against an index of phonemes from content archives. For example, the consumer selects search from a menu and provides a search phrase using the consuming device. The computer system converts the search phrase into phonemes, which are compared to an index of phonemes tied to content. Matched content is then accessible to the consumer, which is further filterable such as by title, date, content producer, or other similar parameters. The consumer then reviews and accesses the matched content. The content is accessed by the consumer using full transport controls such as pause, rewind, restart, fast-forward, and skip.

In one embodiment, the consumer is able to interact with accessed content, such as with an audio, visual, or text message having commentary or suggestions or an approval, disapproval, or vote indication, which is deliverable to the content producer or some other entity (see APPENDIX B for source code examples). For example, when consumer interaction is enabled for content, the consumer is able to make a selection for interaction while consuming the content. Upon making the selection, the consumer is provided an opportunity to capture an audio, text, or visual message or other indication, such as with or by using the consuming device. The consumer is presented with options such as a selection for help, a selection for reviewing the message, a selection for deleting and re-capturing the message, a selection for saving the message, a selection for sending the message to the content producer or other entity, a selection for resuming the content, or some other similar selection. In one particular embodiment, the message is reviewed, such as by an administrator, prior to being sent to the content producer or other entity. In a further embodiment, the message is made available as content for consumption by one or more other consumers. As another example, the consumer is provided an opportunity to capture an audio, text, or visual message or other indication pertaining to content with or using the consuming device to forward to one or more other consumers for review, such as a friend, family member, or business associate who would have an interest in the content. While consuming content, the consumer makes a selection to capture a message and indicates a start and stop position of the content for which the message pertains. The consumer provides contact information, such as a phone number, for one or more other consumers and the computer system sends the message or instructions for accessing the message, such as a text message with a phone number to call, to the one or more other consumers. In one particular embodiment, the computer system optionally recognizes the one or more other consumers to automatically deliver the message. The one or more other consumers then access the message and the pertinent content using a consuming device. The one or more other consumers can be further presented with options such as a selection for help, a selection for reviewing the message, a selection for deleting the message, a selection for saving the message, a selection for recording their own message, a selection for responding to the message, or a selection for forwarding the message to one or more additional consumers. In another particular embodiment, consumers are able to rate content, such as with favorable or negative ratings, whereby more favorably rated content is highlighted or made more accessible to other consumers.

In certain embodiments, the invention includes various consumer plans for accessing content. A first plan provides free access to content that includes advertisements disposed before, after, or during the content; the advertisements generate revenue to compensate for free access to the content. With the first plan, any details described for any embodiment herein are restrictable from the consumer, including amount of content available for consumption during a given time period. A second plan provides for fee-based access to content having reduced advertisements, only sponsorship advertisements, skippable advertisements, or no advertisements. The fee can be a subscription that is periodically paid or can be a pay-per-access fee. A third plan provides for fee-based access to content having limited or no advertisements similar to the second plan, but also includes additional communication network access, such as additional mobile telephone air time. With the third plan, revenue from the fee-based access is usable to compensate communication network carriers such as mobile telephone carriers. A mobile telephone company is motivated to increase mobile telephone air time for providing access to content to sell additional minutes, create a competitive advantage, and increase revenues. Accordingly, in certain embodiments a mobile telephone company markets various aspects of the invention without charge. Because the first and second plans do not necessarily include additional communication network access, the invention can include services to assist a consumer in tracking communication network usage such as an alarm. The alarm can be in a form of a text message, an audio interruption, or some other method. In one particular embodiment, any feature of any plan is interchangeable and additional or fewer plans are establishable. In yet another embodiment, revenue is generated from advertisers for advertisements, from consumers for fee-based access to content, from consumers for user-generated content, from consumers for increased communication network usage, from consumers for pay-per-access services, from content producers for content integration, and from many other sources. Revenues are distributable to content producers, advertisers, communication network providers, or others.

In one embodiment, the computer system includes three computers networked using a switch. The first computer is configurable to receive an incoming telephone call, such as via SIP protocol, and can include multiple sessions depending on available bandwidth. The first computer operates as a router and automatically routes data packets to either of the second and third computers depending on load balancing and failover configurations. In one particular embodiment, the first computer uses Linux Red Hat Fedora® as an operating system and SIP Express Router® as a routing application. The second and the third computers each store a replicated copy of audio content files in a database, such as MySQL®, and preferably run Asterisk® as PBX software for audio content delivery to a consumer. The first, second, and third computers reside behind a firewall for security and can be disposed within a communications provider network, such as XO Communications®, or a telephone company network. Any other computer system configuration, software application, or network protocols may be employed. In additional embodiments, the computer system is replicated at various geographic locations around the world to improve overall network efficiency. Incoming network traffic is automatically routed to a given computer system based on a least cost-of-network-usage analysis. Further, outbound network traffic is automatically configured to originate from a given computer system based on a least cost-of-network-usage analysis or a consideration of intra- and inter-state telephone call rates. In embodiments with replicated computer systems, audio content on each of the computer systems is monitored and automatically synchronized using a software application. In one embodiment, the internet interface is provided using a web server that includes a scripting application to communicate with the database on any of the second and third computers within the computer system. Thus, the same database is sharable between the internet and telephone interfaces. In one particular embodiment, the web server is Apache® and the scripting application is written in PHP.

While preferred and alternate embodiments of the invention have been illustarated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A system for providing a content portal, the system comprising:
a computer system,
the computer system being accessible to a content producer, an advertiser, and a consuming device over a communications network,
the computer system configurable to receiving content from the content producer and an advertisement from the advertiser,
the computer system configurable to distributing the content and the advertisement to a consumer upon the consumer accessing the computer system using the consuming device, and
the computer system configurable to providing transport controls for any of the content and the advertisement.

2. The system of claim 1 wherein the communications network is a telephony-based network, the consuming device is a phone, and the content is any of audio and visual.

3. The system of claim 2 wherein the computer system is further accessible to the consumer via an internet interface.

4. The system of claim 3 wherein the advertisement is tailorably distributed to the consumer based upon any of geography, demographics, preferences, and consumption history of the consumer.

5. The system of claim 4 wherein the advertisement is interactive and the computer system is configurable to managing requests from the consumer for any of engaging with a representative of the advertisement, requesting contact from a representative of the advertisement, requesting additional information regarding the advertisement, and purchasing from the advertiser.

6. The system of claim 5 wherein the interactive advertisement is a paid by the advertiser per consumer interaction.

7. The system of claim 5 wherein the computer system is configurable to storing any of payment information, shipping information, and contact information of the consumer to facilitate requests from the consumer for purchasing from the advertiser.

8. The system of claim 3 wherein the content is interactive and the computer system is configurable to managing requests from the consumer for any of communicating with the content producer, sending a message to the content producer, voicing satisfaction with the content to the content producer, answering a survey from the content producer, and sending a message about the content to another consumer.

9. The system of claim 3 wherein the content producer is another consumer and the content is independently generated by the other consumer using another consuming device for distribution to the consumer.

10. The system of claim 3 wherein the advertiser is another consumer and the advertisement is independently generated by the other consumer using another consuming device for distribution to the consumer.
